(19) United States
(12) Patent Application Publication
(10) Pub. No.: US 2019/0294637 A1
(43) Pub. Date: Sep. 26, 2019

(54) SIMILAR DATA SEARCH DEVICE, SIMILAR DATA SEARCH METHOD, AND RECORDING MEDIUM

(71) Applicant: NEC Corporation, Minato-ku, Tokyo (JP)

(72) Inventor: Kiyoshi YAMABANA, Tokyo (JP)

(73) Assignee: NEC Corporation, Minato-ku, Tokyo (JP)

(21) Appl. No.: 16/316,379

(22) PCT Filed: Jul. 7, 2017
(86) PCT No.: PCT/JP2017/024884

§ 371 Date: Jan. 9, 2019

(30) Foreign Application Priority Data
Jul. 12, 2016 (JP) 2016-137824

(51) Int. Cl. G06F 16/9032; G06F 16/901; G06F 16/903

(52) U.S. Cl. CPC G06F 16/90328; G06F 16/90348; G06F 16/901

(57) ABSTRACT

The present invention is provided with: an inverted index storage unit 11 that stores a plurality of inverted indexes which are used to search, on the basis of the similarity between sets, and which are enabled in the respective similarity threshold ranges, in which a part or the whole of one of the threshold ranges in which at least one of the inverted indexes is enabled is not included in another one of the threshold ranges in which at least one of the other inverted indexes is enabled; an inverted index selection unit 12 that selects an inverted index for search on the basis of the similarity threshold and the threshold ranges in which the respective inverted indexes are enabled; and a data search unit 13 that searches for the search object data similar to the search condition data by using the inverted index for search.

### TECHNICAL FIELD

The present invention relates to a technique for searching for information, based on similarity between sets.

### BACKGROUND ART

A technique for searching for information, based on similarity between sets is known.

For example, a related art described in NPL 1 searches for a similar character string, based on similarity between sets. The related art handles a character string to be searched as a set including, as an element, information (e.g. tri-gram) indicating a feature of the character string. The related art generates an inverted index from the character strings to be searched. The inverted index is information in which an element of a set is set as a key, the sets including the element are assigned as the values associated with the key. In other words, an inverted index in the related art is information in which an element indicating a feature of a character string is set as a key, the character string is set as a value, and thereby these are associated with each other. The related art divides an inverted index in such a way that the size of a character string as a set is the same for all character strings included in one inverted index when generating inverted indexes. The size of a character string as a set means the number of elements in the set and herein is the number of pieces of information indicating features extracted from the character string. In other words, with regard to character strings searchable by using one divided inverted index, the number of pieces of information indicating a feature thereof is the same. The related art determines, upon search, a restriction on the size of character strings as a set to be searched, from the size of the input character string as a set, and narrows down in advance the inverted indexes used for search by using the determined restriction. Thereby, the related art is able to execute search and precise judgement thereafter at high speed.

A related art described in PTL 1 is also a technique for searching for a similar character string, based on similarity between sets. The related art divides, similarly to NPL 1, an inverted index, based on a size of a set. However, the related art does not require the size of a character string as a set to be the same for all character strings included in one inverted index. The related art specifies a minimum value of the number of character strings included in one inverted index and divides an inverted index accordingly. Thereby, the related art can avoid shortcomings of NPL 1 that the number of inverted indexes may excessively increase or the number of search target data may become unbalanced among inverted indexes so search becomes inefficient.

A related art described in NPL 2 is a technique to search character strings where the edit distance between the character string and the query string is equal to or less than a predetermined threshold, by formulating the problem as an overlap problem of signature sets obtained from the query string and the search-target character string. The signature is an element for generating a solution candidate. The related art generates an inverted index, based on signature sets obtained from the character strings to be searched. An edit distance threshold as a search condition is a non-negative integer due to the nature of the problem. When the threshold is changed, the signature set changes, and therefore it becomes necessary to regenerate the inverted index. To overcome this problem, the related art generates an inverted index searchable by an element of the signature sets and a possible non-negative integer value as an edit distance. Specifically, the related art stores, in an inverted index, a pair of an element of a search-target set and a non-negative integer as a search key, where the latter integer number is obtained as the minimum edit distance value so that the former element belongs to the signature set of the search-target set associated with the edit distance. The related art searches the inverted index by using, as a key, each element of the signature set obtained from the query string and each non-negative integer equal to or less than the edit distance threshold specified as the search condition, and obtains character strings as result candidates. Therefore, the related art does not need to regenerate the inverted index every time the search condition threshold changes.

### CITATION LIST

### Non Patent Literature

[NPL 1] Naoaki Okazaki, Junichi Tsujii, “A Simple and Fast Algorithm for Approximate String Matching with Set Similarity”, Natural Language Processing, Vol. 18, No. 2, June 2011, pp. 89-117

[NPL 2] JIANBIN QIN, WEI WANG, CHUAN XIAO, YIFEI LU, XUEMIN LIN, HAIXUN WANG, “Asymmetric Signature Schemes for Efficient Exact Edit Similarity Query Processing”, ACM Transactions on Database Systems Vol. 38 No. 3, August 2013, Article 16 8.1

### PATENT LITERATURE

PTL 1: International Publication No. WO 2014/136810

### SUMMARY OF INVENTION

### Technical Problem

However, as in the related arts described in PTL 1 and NPL 1, in an approach where a search target is narrowed down based on the size of the search target set, a narrowing-down effectiveness may not always be sufficiently obtained, depending on the definition of similarity between sets. To this problem, the related art described in NPL 2 employs an approach that a search target is narrowed down based on the signature of the search target set, and accomplishes fast search to some extent even when narrowing-down based on the set size is not effective. However, the value of the similarity measure employed in NPL 2, namely the edit distance between two character strings, is limited to non-negative integers. Therefore, it is difficult for the related art described in NPL 2 to be applied as-is to a case where similarity may take any real number value included in a predetermined range. One example of such a case is a case where similarity is defined as a non-negative real number value calculated based on a weight of an element of a set.

In such a case, the related art described in NPL 2 would in advance generate an inverted index searchable by respective real numbers possible as similarity values. In this related art, the inverted index would be searched, as a key, with all respective real numbers possible as similarity values, equal to or less than the threshold specified as a search condition. It is difficult to generate such an inverted index, and perform search using such an inverted index as described above is inefficient. In other words, when the related art described in NPL 2 is used, in a case where similarity may take any real number value in a predetermined range, it is difficult to execute search using appropriate inverted indexes.

The present invention has been made in order to solve the above-described problems. In other words, an object of the present invention is to provide a technique for executing search based on similarity between sets at higher speed, using inverted indexes that need not be regenerated on a change of similarity threshold, even when the similarity value may take an arbitrary real number.

### Solution to Problem

A similar data search device according to an exemplary aspect of the invention is used when searching for, based on similarity between sets, search target data as a set similar to search condition data as a set; and includes inverted index storage means for storing a plurality of inverted indexes that are enabled for respective ranges of similarity threshold for determining that sets are similar, wherein for at least one inverted index, a part or whole of the threshold range in which the inverted index is enabled is not included in the threshold range in which at least one other inverted index is enabled; inverted index selection means for selecting one or more inverted indexes for search among the plurality of inverted indexes, based on the similarity threshold specified upon search and the threshold ranges in which respective inverted indexes are enabled; and data search means for searching for the search target data similar to the search condition data by using the selected inverted indexes for search.

A method according to an exemplary aspect of the invention is applied when a computer device searches for, based on similarity between sets, search target data as a set similar to search condition data as a set; and includes selecting one or more inverted indexes for search, from among a plurality of inverted indexes that are enabled for respective ranges of similarity threshold for determining that sets are similar, wherein for at least one inverted index a part or whole of the threshold range in which the inverted index is enabled is not included in the threshold range in which at least one other inverted index is enabled, based on the similarity threshold specified upon search and the threshold range in which respective inverted indexes are enabled; and searching for the search target data similar to the search condition data by using the selected inverted indexes for search.

A program according to an exemplary aspect of the invention is used when searching for, based on similarity between sets, search target data as a set similar to search condition data as a set; and causes a computer device to execute inverted index selection processing for one or more inverted indexes for search, from among a plurality of inverted indexes that are enabled for respective ranges of similarity threshold for determining that sets are similar, wherein for at least one inverted index a part or whole of the threshold range where the inverted index is enabled is not included in the threshold range where at least one other inverted index is enabled, based on the similarity threshold specified upon search and the threshold range in which respective inverted indexes are enabled; and data search processing of searching for the search target data similar to the search condition data by using the selected inverted indexes for search.

The object can be also achieved by a recording medium that records the program for searching for similar data according to one aspect of the present invention.

### Advantageous Effects of Invention

The present invention can provide a technique for executing search based on similarity between sets at higher speed, using inverted indexes that need not be regenerated when the similarity threshold is changed, even if the similarity may take an arbitrary real number value.

### BRIEF DESCRIPTION OF DRAWINGS

FIG. 1 is a diagram illustrating a configuration of a function block of a similar data search device as a first example embodiment of the present invention.

FIG. 2 is a diagram illustrating one example of a hardware configuration of the similar data search device as the first example embodiment of the present invention.

FIG. 3 is a flowchart illustrating an operation relating to search executed by the similar data search device as the first example embodiment of the present invention.

FIG. 4 is a diagram illustrating a configuration of a function block of a similar data search device as a second example embodiment of the present invention.

FIG. 5 is a flowchart illustrating an operation in which the similar data search device as the second example embodiment of the present invention generates an inverted index.

FIG. 6 is a flowchart illustrating an operation relating to search executed by the similar data search device as the second example embodiment of the present invention.

FIG. 7 is a diagram illustrating one example of search target data and element weight data in a specific example of the second example embodiment of the present invention.

FIG. 8 is a diagram illustrating one example of a triad generated from one piece of search target data in the specific example of the second example embodiment of the present invention.

FIG. 9 is a diagram illustrating one example of a triad generated from another piece of search target data in the specific example of the second example embodiment of the present invention.

FIG. 10 is a diagram illustrating one example of a triad generated from still another piece of search target data in the specific example of the second example embodiment of the present invention.

FIG. 11 is a diagram illustrating one example of a triad generated from still further another piece of search target data in the specific example of the second example embodiment of the present invention.

FIG. 12 is a diagram illustrating a list of triads generated in the specific example of the second example embodiment of the present invention.

FIG. 13 is a diagram illustrating an example of an inverted index generated in the specific example of the second example embodiment of the present invention.

FIG. 14 is a diagram illustrating another example of an inverted index generated in the specific example of the second example embodiment of the present invention.

FIG. 15 is a diagram illustrating similarity between search target data and a search condition data in the specific example of the second example embodiment of the present invention.

FIG. 16 is a diagram illustrating search executed in the specific example of the second example embodiment of the present invention.

FIG. 17 is a diagram illustrating a configuration of a function block of a similar data search device as a third example embodiment of the present invention.

FIG. 18 is a flowchart illustrating an operation relating to search executed by the similar data search device as the third example embodiment of the present invention.

### EXAMPLE EMBODIMENT

Hereinafter, example embodiments of the present invention are described.

### First Example Embodiment

A first example embodiment of the present invention is described in detail with reference to the drawings. A similar data search device 1 as the first example embodiment of the present invention handles search condition data and search target data as sets, respectively. The similar data search device 1 is a device that searches for, based on similarity between sets, search target data (a set indicating given search target data) as a set similar to search condition data (a set indicating given search condition data) as a set. For example, search condition data and search target data may be word strings. In this case, a word string is a set of words when a word is regarded as an element. In this case, search condition data as a set may be, for example, a set of words included in a word string indicating search condition data. In this case, search target data as a set may be, for example, a set of words included in a word string indicating search target data. However, search condition data and search target data are not limited to a word string and may be any data that can be handled as a set.

[Description of a Configuration]

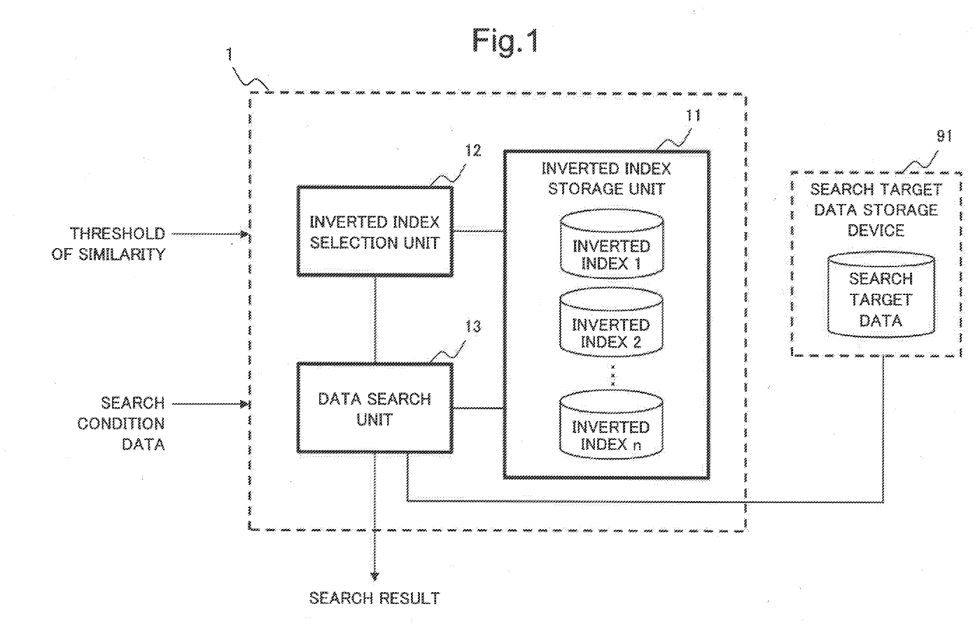

A configuration of function blocks of the similar data search device 1 is illustrated in FIG. 1. In FIG. 1, the similar data search device 1 includes an inverted index storage unit 11, an inverted index selection unit 12, and a data search unit 13. The similar data search device 1 is communicably connected to a search target data storage device 91. The search target data storage device 91 stores one or more pieces of search target data. Each piece of search target data is data that can be regarded as a set containing one or more elements.

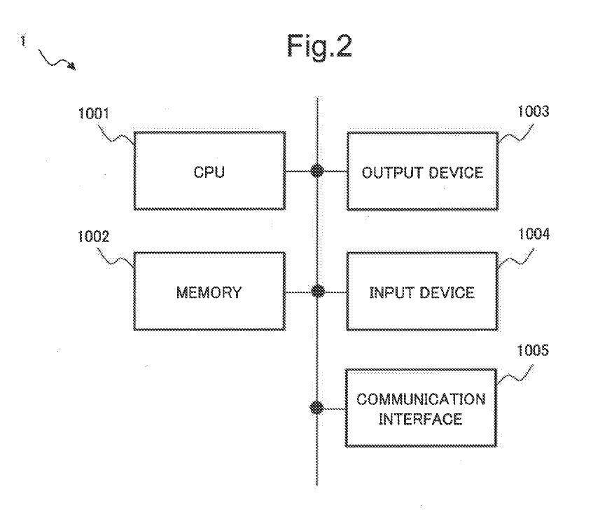

The similar data search device 1 may include hardware elements as illustrated in FIG. 2. In FIG. 2, the similar data search device 1 includes a computer device including a central processing unit (CPU) 1001, a memory 1002, an output device 1003, an input device 1004, and a communication interface 1005. The memory 1002 includes a random access memory (RAM), a read only memory (ROM), an auxiliary storage device (a hard disk or the like) and the like. The memory 1002 stores a computer program for causing the computer device to operate as the similar data search device 1 and various types of data. The output device 1003 includes a device that outputs information such as a display device and a printer. The input device 1004 includes a device that accepts input of user operation such as a keyboard and a mouse. The communication interface 1005 is an interface that enables communication with the search target data storage device 91. In this case, the inverted index storage unit 11 includes the memory 1002. The inverted index selection unit 12 includes the input device 1004 and the CPU 1001 that reads a computer program stored on the memory 1002 and executes the read computer program. The data search unit 13 includes the output device 1003, the input device 1004, the communication interface 1005, and the CPU 1001 that reads a computer program stored on the memory 1002 and executes the read computer program. The similar data search device 1 and a hardware configuration of each function block of the device are not limited to the above-described configurations.

Next, details of each function block of the similar data search device 1 are described.

The inverted index storage unit 11 stores a plurality of inverted indexes. The plurality of inverted indexes are indexes configured to be used when search target data as a set similar to search condition data as a set are searched based on similarity between sets. The similarity is information indicating a degree where two sets are similar. Each inverted index is configured in such a way as to be enabled for a range of similarity threshold. Specifically, each inverted index may be associated with a range of similarity threshold where the inverted index is enabled. The similarity threshold indicates a value in which, when similarity between given sets is equal to or more than the value, it is determined that these sets are similar. In other words, each inverted index is configured to be enabled when a similarity threshold included in a range of similarity threshold relating to the inverted index is specified in search. In other words, the range of similarity threshold for an inverted index indicates the range that can be specified as a similarity threshold in a search where the given inverted index is enabled. Hereinafter, a range of similarity threshold is also described simply as a threshold range.

A plurality of inverted indexes are configured in such a way that for at least one inverted index a part or the whole of the threshold range where the inverted index is enabled is not included in a threshold range where at least one other inverted index is enabled. Further, a plurality of inverted indexes are preferably configured in such a way that any similarity threshold value that can be specified upon search is included in a range where at least one inverted index among the plurality of inverted indexes is enabled.

The inverted index storage unit 11 stores each inverted index and information indicating a threshold range where the inverted index is enabled in association with each other.

The inverted index selection unit 12 selects one or more inverted indexes for search, based on the similarity threshold specified upon search and the threshold ranges where respective inverted indexes are enabled. Specifically, the inverted index selection unit 12 may select, as inverted indexes for search, inverted indexes that are enabled for a threshold range including the specified similarity threshold. As selected inverted indexes for search, one or a plurality of the inverted indexes are applicable. A similarity threshold may be obtained via the input device 1004. A similarity threshold may be obtained from the memory 1002, a portable storage medium or another device connected via a network.

The data search unit 13 searches for search target data similar to search condition data using the selected inverted indexes for search. Search condition data may be obtained via the input device 1004. Search condition data may be obtained from the memory 1002, a portable storage medium, or another device connected via a network.

[Description of an Operation]

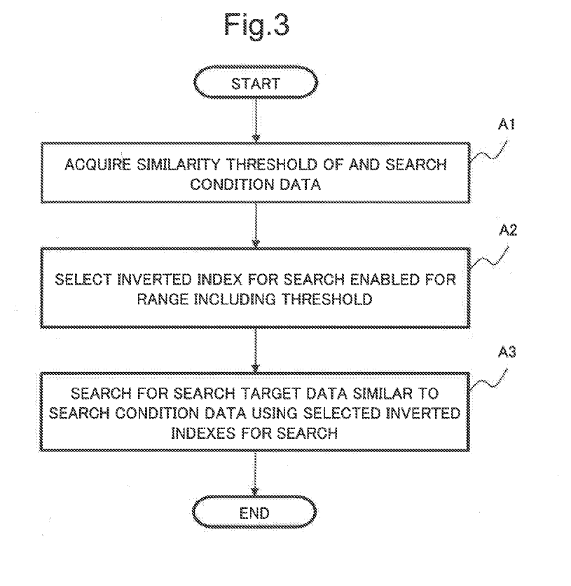

The search operation executed by the similar data search device 1 configured as described above is illustrated in FIG. 3.

In FIG. 3, first, the similar data search device 1 acquires a similarity threshold and search condition data (step A1).

The inverted index selection unit 12 selects one or more inverted indexes for search from among a plurality of inverted indexes, based on the obtained threshold of similarity and a threshold range where each inverted index is enabled (step A2). As described above, the inverted index selection unit 12 may select, as an inverted index for search, an inverted index enabled for a range including the obtained threshold of similarity.

The data search unit 13 searches for search target data similar to the search condition data using the selected inverted indexes for search (step A3).

This concludes the description of the search operation executed by the similar data search device 1.

[Description of an Advantageous Effect]

Next, an advantageous effect of the first example embodiment of the present invention is described.

The similar data search device 1 of the present example embodiment can execute higher-speed search based on similarity between sets, using inverted indexes that need not be regenerated on a change of similarity threshold, even when the similarity may take any real number value.

The reason is that in the present example embodiment, the similar data search device 1 is configured as follows. The inverted index storage unit 11 is configured to store a plurality of inverted indexes. The plurality of inverted indexes are configured to be used when search target data as a set similar to search condition data as a set are searched based on similarity between sets. Each inverted index is associated with, for example, a range of similarity threshold used to judge that two sets are similar, and each inverted index is configured so that it is enabled for the associated range of similarity threshold. The inverted indexes are configured so that at least for one inverted index a part or the whole of the threshold range where the inverted index is enabled is not included in a threshold range where at least one other inverted index is enabled. The inverted index selection unit 12 is configured to select one or more inverted indexes for search from among a plurality of inverted indexes, based on the similarity threshold specified upon search and the threshold ranges where respective inverted indexes are enabled. The data search unit 13 is configured to perform search for search target data similar to search condition data using the selected inverted index for search.

In this manner, in the present example embodiment, the similar data search device 1 selects inverted indexes for search enabled for ranges including the similarity threshold and thereby executes search. Therefore, the similar data search device 1 in the present example embodiment can select inverted indexes enabled for any real number value specified as the similarity threshold and does not need to regenerate inverted indexes even when the similarity threshold changes. In the present example embodiment, for at least one inverted index, a part or the whole of the threshold range where the inverted index is enabled is not included in a threshold range where at least one other inverted index is enabled. Therefore, it is highly possible that the number of the selected inverted indexes for search be narrowed down to a smaller number than the number of all inverted indexes. As a result, the similar data search device 1 according to the present example embodiment can execute, at higher speed, effective search suitable for the similarity threshold specified upon search.

### Second Example Embodiment

Next, a second example embodiment of the present invention is described in detail with reference to the drawings. In the present example embodiment, a specific example in which a configuration for generating inverted indexes is added to the first example embodiment of the present invention is described. A specific example in which a real number calculated from a non-negative weight provided to each element of a set is defined as a similarity is described. In the drawings referred to in description of the present example embodiment, the same components as in the first example embodiment of the present invention and steps similarly operated are assigned with the same reference signs, and their detailed description in the present example embodiment is omitted.

[Description of a Configuration]

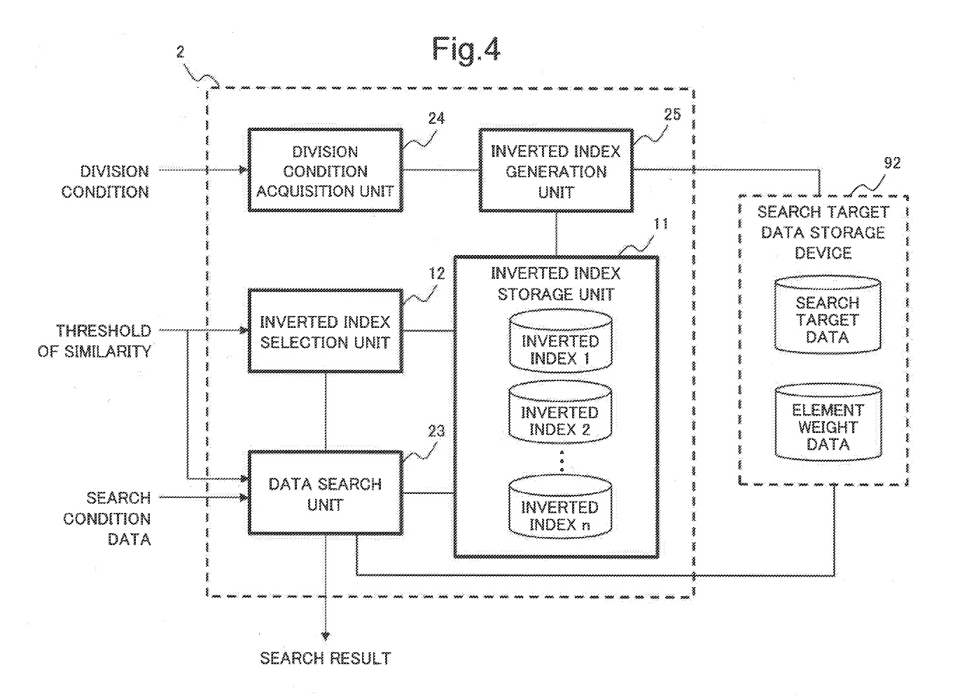

First, a function block configuration of a similar data search device 2 as the second example embodiment of the present invention is illustrated in FIG. 4. In FIG. 4, the similar data search device 2 includes a data search unit 23 instead of the data search unit 13, in contrast with the similar data search device 1 as in the first example embodiment of the present invention. Further, the similar data search device 2 is different from the similar data search device 1 in a point that a division condition acquisition unit 24 and an inverted index generation unit 25 are included. Further, the similar data search device 2 is different from the similar data search device 1 in a point that the similar data search device 2 is connected to a search target data storage device 92, instead of the search target data storage device 91. The search target data storage device 92 stores, in addition to search target data, element weight data indicating a weight applied to each element of the search target data. Herein, a weight is a non-negative real number value.

The similar data search device 2 and each function block thereof can be configured by using hardware elements similar to corresponding hardware elements of the first example embodiment of the present invention described with reference to FIG. 2. In this case, the division condition acquisition unit 24 includes an input device 1004 and a CPU 1001 that reads a computer program stored on a memory 1002 and executes the read computer program. The inverted index generation unit 25 includes a communication interface 1005 and a CPU 1001 that reads a computer program stored on the memory 1002 and executes the read computer program. However, a hardware configuration of the similar data search device 2 and each function block thereof is not limited to the above-described configuration.

The division condition acquisition unit 24 acquires information indicating a division condition of an inverted index. The division condition may be, for example, a condition based on threshold ranges, or a condition based on the number of entries included in each inverted index, or the like. However, a content of division condition is not limited thereto. Details of division condition will be described later.

The inverted index generation unit 25 generates a plurality of inverted indexes from search target data, based on a division condition. The inverted index generation unit 25 refers to search target data and element weight data stored on the search target data storage device 92 when generating an inverted index. A plurality of inverted indexes are generated in such a way that each index is enabled for some range of similarity threshold, as described in the first example embodiment of the present invention. Inverted indexes are generated in such a way that for at least one inverted index a part or the whole of the threshold range where the inverted index is enabled is not included in the threshold range where at least one other inverted index is enabled. Inverted indexes are preferably configured in such a way that a similarity threshold that can be specified upon search is included in a threshold range for at least one inverted index.

The inverted index generation unit 25 stores, on the inverted index storage unit 11, information indicating each generated inverted index in association with information indicating a threshold range where the inverted index is enabled.

The data search unit 23 searches for data that might be similar to the search condition data, using the inverted indexes for search. The data search unit 23 may search the inverted indexes for search, for example, using as a key each element of search condition data as a set. The data search unit 23 calculates set similarity between search target data obtained by inverted index search and search condition data, and outputs target data as a search result if the calculated similarity is equal to or more than the similarity threshold.

[Description of an Operation]

An operation of the similar data search device 2 configured as described above is described with reference to the drawings. For description of the operation, several symbols are defined.

First, a family of sets that are search target data is represented by Σ. The family Σ of sets may indicate the entire search data. A search target data is represented by S(∈Σ). S itself is a set. An element of S is represented by s. Hereinafter, a set S that indicates search target data is described simply as S or as search target data S. When each s that is an element of S is represented by using a subscript i, a set S is expressed, for example, as “S={sᵢ} (0≤i≤card(S)−1)”. The symbol “card(S)” represents the number of elements of S. However, in the followings, a subscript range will be omitted except for the case where it is necessary in particular. A weight of sᵢ is represented by wᵢ.

Search condition data are represented by T. T is also a set. Hereinafter, a set T that indicates search condition data is described simply as T or as search condition data T. Similarity between two sets, S and T, is represented as sim(S, T). A threshold for judging similarity (similarity threshold) in search is represented as λ. Search target data in which similarity is less than λ are not judged as being similar to the search condition data and will not be included in the similarity search result. On the other hand, search target data in which similarity is equal to or more than λ are judged as being similar to the search condition data and will be included in the similarity search result.

<Generation Operation of an Inverted Index>

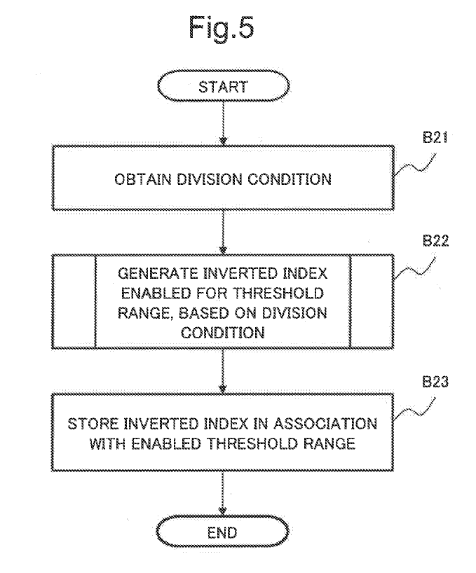

An operation for generating an inverted index executed by the similarity data search device 2 is illustrated in FIG. 5.

In FIG. 5, first, the division condition acquisition unit 24 obtains information indicating a division condition of an inverted index (step B21).

The inverted index generation unit 25 refers to search target data and element weight data stored on the search target data storage device 92 and generates inverted indexes 1 to n, based on the division condition obtained in step B21. The symbol n is an integer equal to or more than 2 (step B22).

As described above, the inverted indexes 1 to n generated in step B22 are generated in such a way as to be enabled for respective ranges of similarity threshold. The inverted indexes 1 to n may be generated, for example, in such a way as to be enabled for different similarity threshold ranges from one another. The inverted indexes 1 to n are generated in such a way that for at least one inverted index a part or the whole of the threshold range where the inverted index is enabled is not included in a threshold range where at least one other inverted index is enabled. A plurality of inverted indexes are preferably configured in such a way that any similarity threshold that can be specified upon search is included in the threshold range of at least one inverted index. In this case, inverted indexes may be configured in such a way that, for example, the range of similarity threshold that can be specified upon search is equal to a threshold range for at least one inverted index. A specific example of step B22 is described later.

The inverted index generation unit 25 stores, on the inverted index storage unit 11, information indicating each inverted index and information indicating a threshold range where each inverted index is enabled in association with each other (step B23).

Assume that, for example, a value of similarity sim between sets is [0.0, 1.0]. [×1, ×2] indicates a range of real number values equal to or more than ×1 and equal to or less than ×2. As one example, suppose that inverted indexes 1 to 3 are generated. In this case, an inverted index 1 may be generated, for example, in such a way as to be enabled for the threshold range of [0.0, 1.0]. An inverted index 2 may be generated, for example, in such a way as to be enabled for the threshold range of [0.0, 0.8]. An inverted index 3 may be generated, for example, in such a way as to be enabled for the threshold range of [0.0, 0.5]. In this case, a range of more than 0.8 and equal to or less than 1.0 that is a part of the range where the inverted index 1 is enabled is configured so that it is not included in the range where the inverted index 2 or the inverted index 3 are enabled. The threshold of similarity [0.0, 1.0] that can be specified upon search is configured so that it is included in a range where at least the inverted index 1 is enabled.

The above concludes a description of the generating operation for an inverted index executed by the similar data search device 2.

<Search Operation Using an Inverted Index>

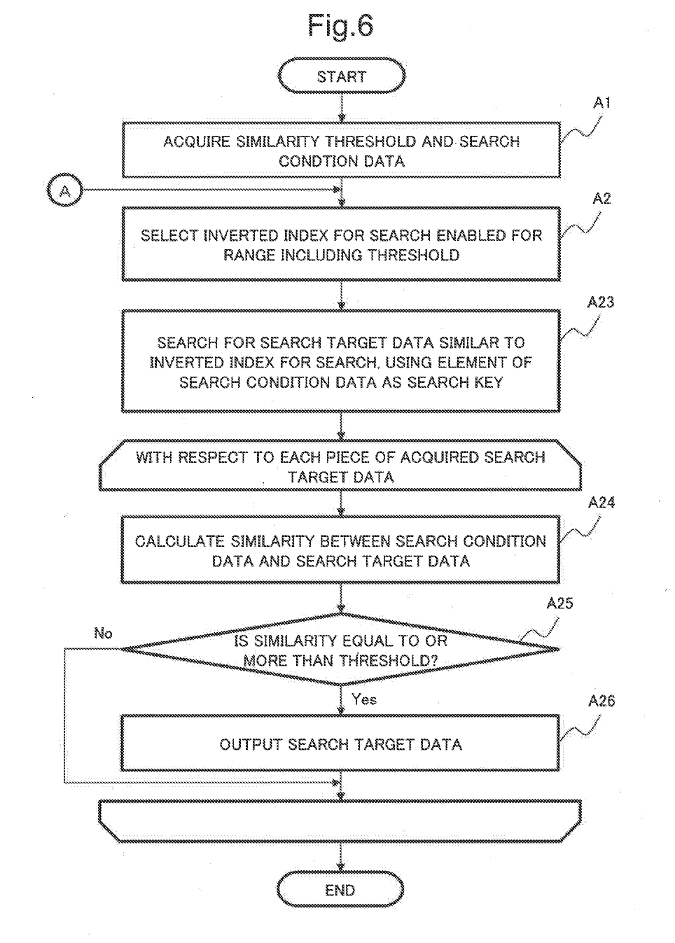

An operation for executing search by the similar data search device 2 is illustrated in FIG. 6. This is an operation in which the similar data search device 2 determines all S∈Σ with sim(S, T)≥λ, with respect to the input search condition data T, and outputs the determined S.

In FIG. 6, first, the inverted index selection unit 12 executes step A1, similarly to the first example embodiment of the present invention and obtains the similarity threshold λ and the search condition data.

The inverted index selection unit 12 executes step A2, similarly to the first example embodiment of the present invention and selects an inverted index for search, based on the similarity threshold λ.

Specifically, the inverted index selection unit 12 selects inverted indexes for search if the threshold λ is included in the enabled similarity threshold range for the index. Suppose that, for example, in the above-described example, λ=0.9. In this case, the only inverted index that includes 0.9 in the similarity threshold range is the inverted index 1. Therefore, in this case, the inverted index selection unit 12 selects the inverted index 1 as the only inverted index for search. Next suppose that λ=0.7. In this case, the inverted index 1 and the inverted index 2 include 0.7 in the enabled threshold range. In this case, the inverted index selection unit 12 selects these two inverted indexes 1 and 2 as the inverted indexes for search.

The data search unit 23 executes search using the selected inverted indexes for search, using as a search key each element v of search condition data T (step A23).

The data search unit 23 repeats the following steps A24 to A26 for each S∈Σ obtained in step A23.

First, the data search unit 23 calculates similarity sim(S,T) between S and T (step A24).

The data search unit 23 determines whether or not the calculated similarity is equal to or more than λ (i.e., if sim(S,T)≥λ is satisfied) (step A25).

When the similarity is equal to or more than λ (Yes in step A25), the data search unit 23 determines that S and T are similar to each other and outputs the S as a search result (step A26).

On the other hand, when the similarity is less than λ (No in step A25), the data search unit 23 determines that S and T are not similar to each other and does not include such S in a search result.

This concludes description of the search operation of the similar data search device 2.

In this manner, the similar data search device 2 narrows down the inverted indexes to be used for search in step A2, executes search (step A23) and calculation of similarity (step A24), and thereby determines search target data similar to search condition data. In other words, the similar data search device 2 selects one or more inverted indexes used for search from among all inverted indexes and executes search (step A23) and calculation of similarity (step A24) by using the selected inverted indexes. Thereby, the similar data search device 2 can search for similar data at high speed, compared with a simple method for calculating similarity for all pieces of search target data and determining similarity.

<Details of Generation Operation of an Inverted Index>

Next, details of an operation for generating a plurality of inverted indexes in step B22 are described. In order to generate a plurality of inverted indexes as described above, the following concept of a signature is used.

A signature sig(S,λ) associated with similarity λ with respect to any search target data S={sᵢ}∈Σ is a subset of S having the following nature.

sim(S,T)≥λ⇒sig(S,λ) and T have at least one common element (Definition 1)

In order to solve, with respect to a given T, the problem of determining all S where sim(S, T)≥λ is satisfied, an inverted index is generated in advance so that the keys are elements of sig(S, λ) and corresponding search result is S. First this inverted index is searched by each element of search condition data T; then sim(S,T) is calculated for all retrieved S∈Σ; and finally S is output if sim(S,T)≥λ. With these steps all S with sim(S, T)≥λ can be obtained. The reason is that any S with sim(S,T)≥λ is certainly retrieved, from the definition 1 above, in the search of the inverted index generated from the signatures sig(S,λ). In particular, when sig(S,λ) is a proper subset of S, the number of keys included in the inverted index becomes smaller than the number of keys in an inverted index generated simply from all elements of S. Therefore, the number of retrieved elements obtained from the index search is decreased, and faster processing can be expected including subsequent similarity calculation. Whether an effective signature can be defined or not depends on specific form of the similarity. An example with an effective signature will be described below.

A weight Weight(X) for a set X is defined as the sum of weights of elements belonging to the set. In other words, when X={xᵢ} is a set and the weight of an element xᵢ in the set X is wᵢ, the weight of X is calculated as Weight(X)=Σwᵢ. A finite sum of the right-hand side is a sum of weights with respect to all elements of X.

Similarity sim(S,T) between S and T is defined as follows, with respect to search condition data T and search target data S.

sim(S,T)=Weight(S∩T)/Weight(S) (Definition 2)

With this definition of similarity, the following property (property 1) holds. In the following description, “Φ” represents an empty set.

With regard to a subset S₀⊆S of S, if Weight(S\S₀)/Weight(S)<λ (“S\S0” represents a complement set of S0 where S is a universal set) and if T∩S₀=Φ, sim(S,T)<λ . . . . (Property 1)

The reason is that if T∩S₀=Φ, then S∩T=(S\S0)∩T, so the following relation holds.

sim(S,T)=Weight(S∩T)/Weight(S)=Weight((S\S₀)∩T)/Weight(S)<Weight(S\S₀)/Weight(S)<λ

Considering the contraposition of the above Property 1, it is understood that a subset S₀ of S with Weight(S\S₀)/Weight(S)<λ is a signature of S with respect to λ. In other words, in order that sim(S,T)≥λ is satisfied, it is necessary that T∩S₀≠Φ. Therefore, with regard to each of search target data S, any subset S₀ with Weight(S\S₀)/Weight(S)<X may be selected and an inverted index may be generated in such a way as to search S by using an element of S₀ as a key. An inverted index generated in such a manner can be effectively used for similarity search where any λ with Weight(S\S₀)/Weight(S)<λ is the threshold.

However, the above-described inverted index is not effective when a threshold λ satisfies λ≤Weight(S\S₀)/Weight(S). The reason is that even when this inverted index is not hit at all, it is possible that such data exist where its similarity to the input set is equal to or more than the threshold and should be included in the similarity search result.

Therefore, when the above-described configuration is employed, every time the threshold changes, it is necessary to regenerate the inverted index according to the new threshold.

In NPL 2, similarity is a non-negative integer having an upper bound and values taken as similarity are finite. Therefore, in NPL 2, for these possible finite values (values that can be considered as similarity), it is possible to calculate signatures in advance and adjust the inverted indexes so that the same search target data are not retrieved by different similarity keys. Thereby, NPL 2 argues that it is unnecessary to regenerate inverted indexes according to a new threshold (see 8.1 Generic Index Construction section in NPL 2). However, when similarity value takes a real number value depending on the weight of each element as in the present example embodiment, there are a very large number of possible values for similarity. Therefore, an approach as in NPL 2 is not realistic.

Hereinafter, a method (details of step B22 of the present example embodiment) for generating inverted indexes, when similarity takes a real number value depending on the weight of each element, is described in such a way that the inverted indexes need not be regenerated even when the threshold changes.

For each S∈Σ, a finite family {Sᵢ} (i=0, . . . , n) of subsets of S is selected in such a way as to satisfy the following.

a) S₀=Φ⊆S₁⊆ . . . ⊆Sₐ=S (Condition a)

b) card(Sᵢ₊₁\S₁)=1 (Condition b)

In other words, any family of subsets of S such that there is a mutual inclusion relation (condition a) and the number of elements increases on a one-by-one basis (condition b) is selected arbitrarily in advance.

In addition, a finite set {λᵢ} of similarities is defined as follows.

c) λᵢ=Weight(S\Sᵢ)/Weight(S) (Definition 3)

Therefore, the following clearly holds.

d) λ₀=1.0>λ₁> . . . ≥Xₐ=0

From c) above, it is understood that Sᵢ is a signature of S effective for a similarity threshold λ upon search with λ>λᵢ.

For any element s∈S of S, choose i=i(s) so that s∉Sᵢ, s∉Sᵢ₊₁

and

define a triad (s,S,λᵢ(s)) including an element s, search target data S, and corresponding similarity X₁(s) . . . . (Definition 4)

Such i(s) is guaranteed to exist from the condition a. For a set {(s,S,λᵢ₍ₛ₎)|s∈S}

of such triad {(s,S,λᵢ₍ₛ₎)}, the following property holds.

With regard to any S∈Σ and a set {(s,S,λᵢ(s))|s∈S} of triads defined as described above, a subset S(μ)={(s|s∈S and μ≤λᵢ(s)} of S is a signature for the threshold μ. In other words, when a set T of search conditions satisfies sim(S,T)≥μ, T∩S(μ)≠Φ . . . . (Property 2)

The reason is that by the definition of S(μ), a certain j exists depending on μ and S(μ)=Sⱼ. Since t such that j=i(t) satisfies t∈S\Sⱼ, therefore λⱼ=λᵢ(t)<μ is satisfied, and when sim(S,T)≥μ, it is inevitable that sim(S,T)≥λⱼ. In this case, from the definition 3 described above, S(μ)=Sⱼ and T certainly have a common element.

A triad (s,S,τ) configured as described above can be regarded as an inverted index with a search key s, the search result S, associated similarity τ, and that is enabled when a threshold equal to or less than τ is specified. When a similarity threshold μ is given, by searching for all triads (s,S,τ) with μ≤τ, all data can be obtained without omission of which the similarity is equal to or more than the threshold μ.

In step B22, the inverted index generation unit 25 allocates all triads generated as described above to a plurality of inverted indexes, based on a division condition acquired by the division condition acquisition unit 24 and thereby generates inverted indexes. Each inverted index is enabled for a threshold equal to or less than the maximum value of similarities associated with included triads. Hence the inverted index generation unit 25 may associate each inverted index with the maximum value of similarities associated with the included triads as information indicating the range where the inverted index is enabled. In this case, when, for example, a threshold is equal to or less than this value (the maximum value of similarities associated with the triads) with respect to a given inverted index, the inverted index is enabled. In other words, the similarity associated with a given inverted index is equal to or more than the threshold, that inverted index is enabled. Thereby, in step A2, the inverted index selection unit 12 may select an inverted index in which associated similarity is equal to or more than the threshold as the inverted indexes for search.

As one example, suppose that a division condition of an inverted index is a condition that “a range of a real number value that can be taken by the similarity associated with a triad is divided into a designated number of intervals and corresponding inverted indexes are generated”. Suppose that similarity used in this specific example has a value in [0.0, 1.0]. This time, assume that the division condition is, for example, dividing the range into five intervals. In this case, the inverted index generation unit 25 generates five indexes correspondingly to intervals of (0.0, 0.2], (0.2, 0.4], (0.4, 0.6], (0.6, 0.8], and (0.8, 1.0]. [x,y] represents a closed interval (a range that is equal to or more than x and equal to or less than y), and (x,y] represents a half-open interval (a range that is truly larger than x and equal to or less than y). The inverted index generation unit 25 may generate, for example, an inverted index including all triads (s,S,μ) in which associated similarity μ, satisfies 0.0≤μ≤0.2, correspondingly to an interval of (0.0, 0.2]. Similarly, the inverted index generation unit 25 can generate five inverted indexes. Each inverted index is associated with, for example, the maximum value of similarity associated with the triads included in the inverted index. When the similarity threshold specified upon search is equal to or less than the maximum value of similarity associated with a given inverted index, that inverted index is enabled. A case in which a similarity threshold upon search is 0.0 indicates that all data are certainly retrieved for any search condition input, and search itself is unnecessary for this case; therefore it is always unnecessary to consider 0.0 as a value of a threshold.

As another example, suppose that in the division condition a minimum value M (M is integer equal to or more than 1) of the number of pieces of data included in each inverted index is specified. In this case, the inverted index generation unit 25 determines, as a first inverted index, a maximum λ=λ₀ where the total number of triads of which the associated similarity is included in [λ, 1.0] is equal to or more than M. The inverted index generation unit 25 generates a first inverted index by including all triads where associated similarity is included in [λ₀, 1.0]. Next, the inverted index generation unit 25 determines a maximum λ=λ₁ where the total number of triads of which the associated similarity is included in [λ, λ₀) is equal to or more than M. The inverted index generation unit 25 generates a second inverted index by including all triads where associated similarity is included in [X₁, X₀). Thereafter, the inverted index generation unit 25 can generate inverted indexes where the number of pieces of included data is equal to or more than M, by repeating this operation. Each inverted index is associated with the maximum value of similarities associated with the triads included in the inverted index. When the similarity threshold specified upon search is equal to or less than the maximum value of similarities associated with a given inverted index, that inverted index is enabled.

As another example, in the division condition the range of possible similarity values associated with the triads may be divided into arbitrary intervals for respective inverted indexes. A division condition may be a combination of a plurality of conditions.

[Description of a Specific Example of an Operation]

Next, an operation of the similarity data search device 2 is described using specific data.

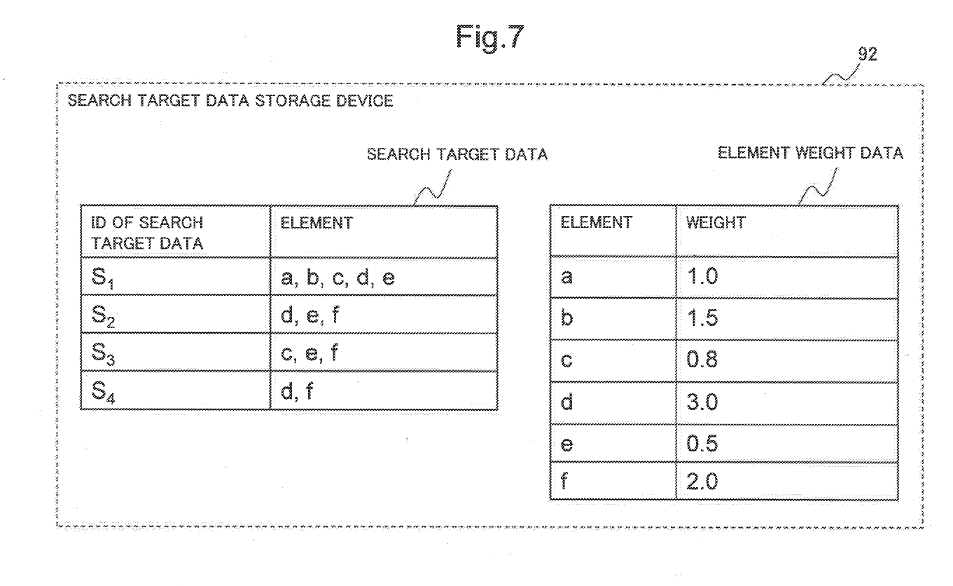

FIG. 7 illustrates search target data and element weight data stored on the search target data storage device 92 in the specific example.

As search target data, four sets of S1 to S4 are stored. S1 is a set including five elements a, b, c, d, and e. S2 is a set including three elements d, e, and f. S3 is a set including three elements c, e, and f. S4 is a set including two elements d and f. As element weight data, a weight provided to each element of the four sets of S1 to S4 is stored. A weight is a non-negative real number value.

<Generation Operation of an Inverted Index (Specific Example)>

Next, an operation for generating an inverted index by the inverted index generation unit 25 from the search target data and the element weight data of FIG. 7 is specifically described.

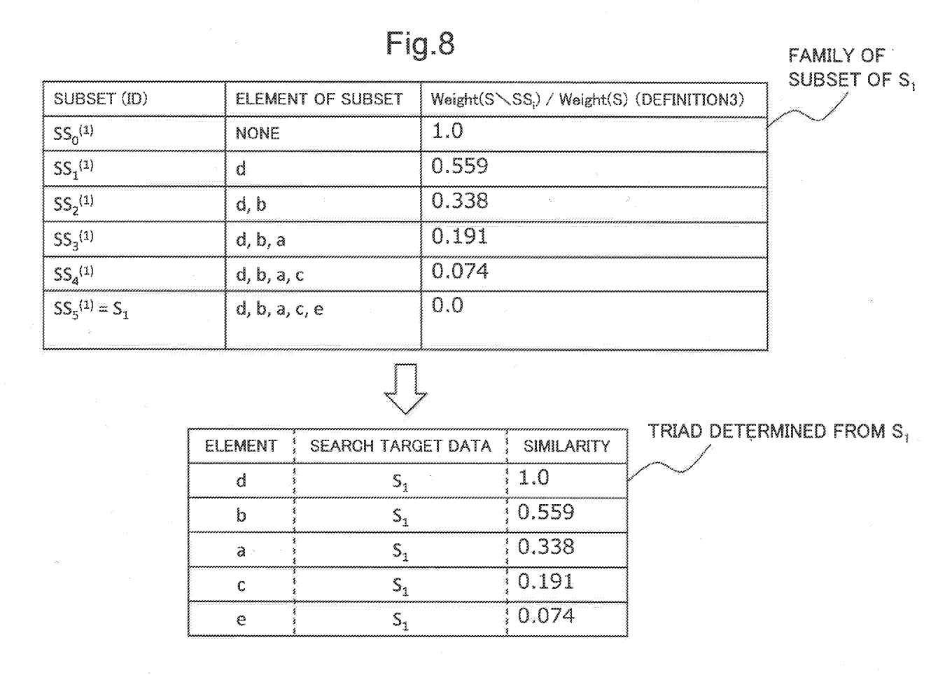

First, the inverted index generation unit 25 selects a family of subsets in such a way as to satisfy condition a and condition b described above, with respect to each of pieces of search target data S₁ to S₄. FIG. 8 illustrates, for example, an example of a family of subsets selected for S1 and a corresponding triad. Subsets SS₀⁽¹⁾ to SS₅⁽¹⁾ of S₁ clearly satisfy condition a and condition b as illustrated. The value of the third column is similarity λᵢ calculated based on definition 3.

In this case, the inverted index generation unit 25 configures a triad for each element of search target data S₁ in accordance with definition 4. The configured triad is as illustrated in FIG. 8. For example, the element d is not included in SS₀⁽¹⁾ but is included in SS₁⁽¹⁾. Therefore, “i=i(d) such that d∉Sᵢ and d∈Sᵢ₊₁” as referred to in definition 4 is 0.

The value of the third element of a triad is 1.0 that is the value of definition 3 for SS₀⁽¹⁾. Therefore, as a triad, (d, S₁, 1.0) is obtained. Similarly, the element b is not included in SS₁⁽¹⁾ but is included in SS₂⁽¹⁾. Therefore, “i=i(b) such that b∉S, and b∈Sᵢ₊₁” as referred to in definition 4 is 1.

The value of the third element of a triad is 0.559 that is the value of definition 3 for SS₁⁽¹⁾. Therefore, as a triad, (b, S₁, 0.559) is obtained. With regard to other elements, similarly, a triad is obtained based on information of subsets SS₀⁽¹⁾ to SS₅⁽¹⁾ of S₁. As a result, five triads based on S₁ are, as illustrated in FIG. 8, (d, S₁, 1.0), (b, S₁, 0.559), (a, S₁, 0.338), (c, S₁, 0.191), and (e, S₁, 0.074).

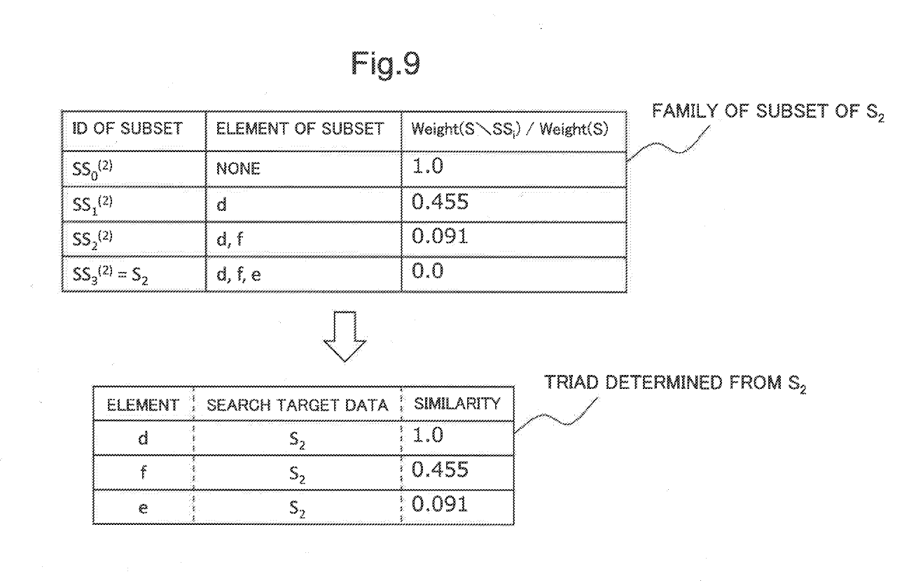

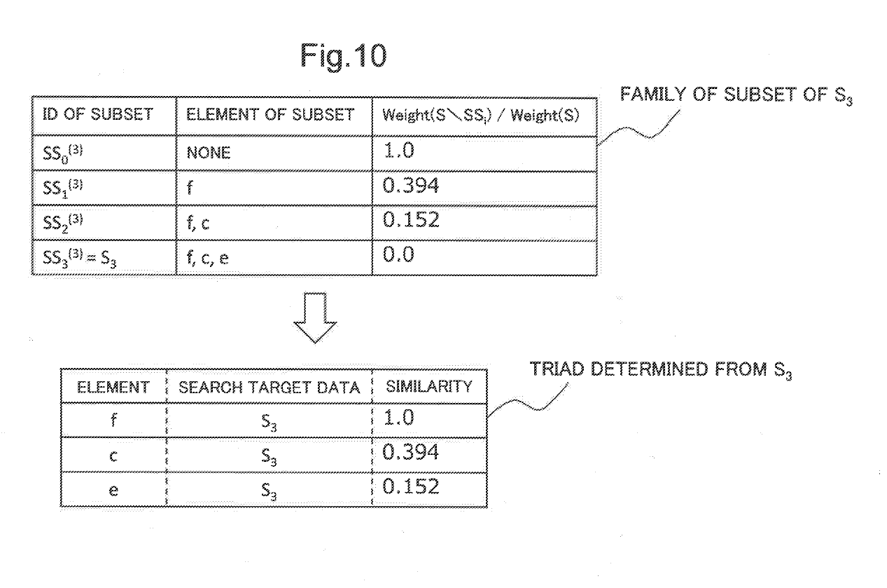

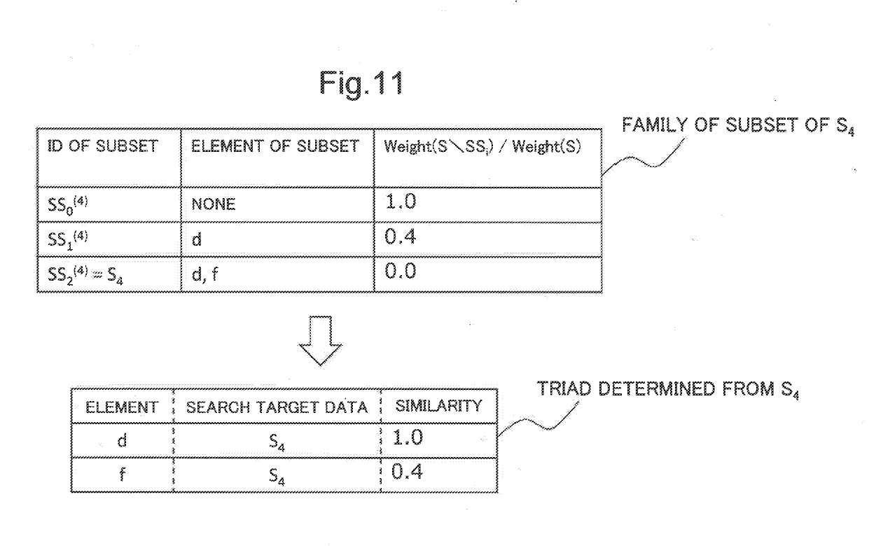

FIG. 9 illustrates an example of a family of subsets for search target data S₂ and triads obtained from the family of the subsets. FIG. 10 illustrates an example of a family of subsets for search target data S₃ and triads obtained from the family of the subsets. FIG. 11 illustrates an example of a family of subsets for search target data S₄ and triads obtained from the family of the subsets.

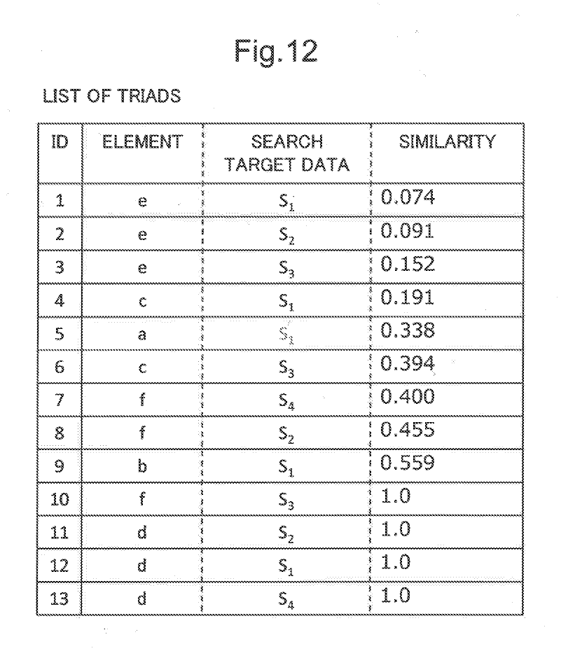

In FIG. 12, a list of triads obtained in this manner is illustrated. For convenience of description, via sorting in ascending order of similarity, an ID is assigned to each triad.

The inverted index generation unit 25 generates a plurality of inverted indexes each enabled for respective threshold range, in accordance with the division condition obtained by the division condition acquisition unit 24.

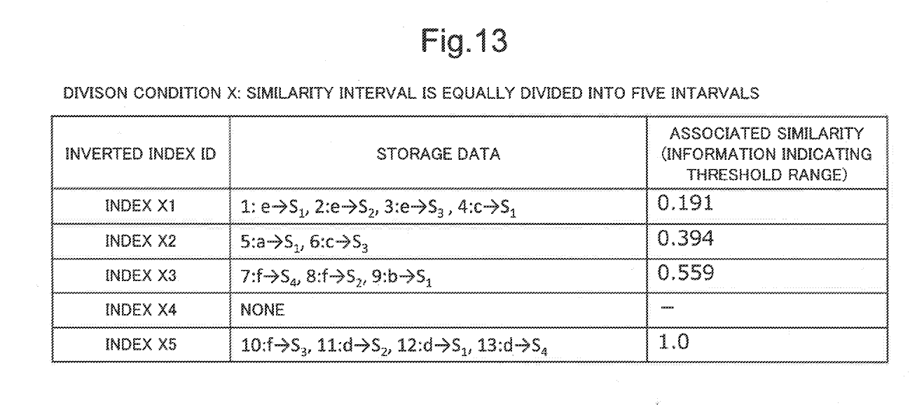

Assume that a division condition is “a division condition X for specifying that a range ([0.0, 1.0]) of a real number value that can be taken by similarity is equally divided into five intervals”. FIG. 13 is a diagram illustrating an inverted index generated based on the division condition X. In this case, the inverted index generation unit 25 generates five inverted indexes correspondingly to intervals of (0.0, 0.2], (0.2, 0.4], (0.4, 0.6], (0.6, 0.8], and (0.8, 1.0].

First, the inverted index generation unit 25 generates, for the interval (0.0, 0.2], an inverted index X1 that stores triads of ID=1, 2, 3, and 4, of which the associated similarity is included in this interval. “1:e→S1” and the like illustrated in FIG. 13 are used as a notation indicating a triad. For example, “1:e→S1” indicates a triad in which ID is 1, an element is e, and a set is S₁. In this notation, description of the third element of a triad is omitted.

The inverted index generation unit 25 generates, for the interval (0.2, 0.4], an inverted index X2 that stores triads of ID=5 and 6, of which the associated similarity is included in this interval.

The inverted index generation unit 25 generates, for the interval (0.4, 0.6], an inverted index X3 that stores triads of ID=7, 8, and 9, of which the associated similarity is included in this interval.

With regard to the interval (0.6, 0.8], there is no triad of which the associated similarity is included in this interval. Therefore, the inverted index generation unit 25 does not generate an inverted index X4 corresponding to this interval, or generates an empty inverted index X4 without any data in it.

The inverted index generation unit 25 generates, for the interval (0.8, 1.0], an inverted index X5 that stores triads of ID=10, 11, 12, and 13, of which the associated similarities are included in this interval.

Storing triads in an inverted index indicates that a set element that is a first element of a triad is considered as a key of the index and the inverted index is configured in such a way that search target data that are a second element are searched by using this key. In the above-described example, the inverted index X1 stores, for example, e and c as a search key. The inverted index X1 is configured in such a way that when search is executed by using the key e, S1, S2, and S3 are obtained and when search is executed by using the key c, S1 is obtained. For example, the inverted index X3 stores f and b as a search key. The inverted index X3 is configured in such a way that when search is executed by using the key f, S2 and S4 are obtained and when search is executed by using the key b, S1 is obtained.

The inverted index generation unit 25 associates each inverted index with the maximum value of similarities associated with the stored triads as information indicating the threshold range where the inverted index is enabled. The inverted index X1 stores, for example, triads of ID=1, 2, 3, and 4. Of these, the maximum value of associated similarities is 0.191 associated with the triad with ID=4. Therefore, the inverted index generation unit 25 associates the inverted index X1 with the value 0.191. In short, the inverted index X1 is enabled in search with the threshold equal to or less than 0.191.

With regard to triads stored in the inverted index X2, the maximum value of associated similarities is 0.394 associated with the triad with ID=6. The inverted index generation unit 25 associates the inverted index X2 with the value 0.394. In short, the inverted index X2 is enabled in search with the threshold equal to or less than 0.394.

Similarly, the inverted index generation unit 25 associates the inverted index X3 with similarity 0.559 and associates the inverted index X5 with similarity 1.0. If the inverted index X4 is not generated, association with similarity does not exist. Alternatively, when the inverted index X4 is generated without any data in it, search is not affected, and therefore association with any similarity is possible. For example, the inverted index X4 may be associated with similarity 0.0 so that X4 will never be selected as an inverted index for search under any search condition.

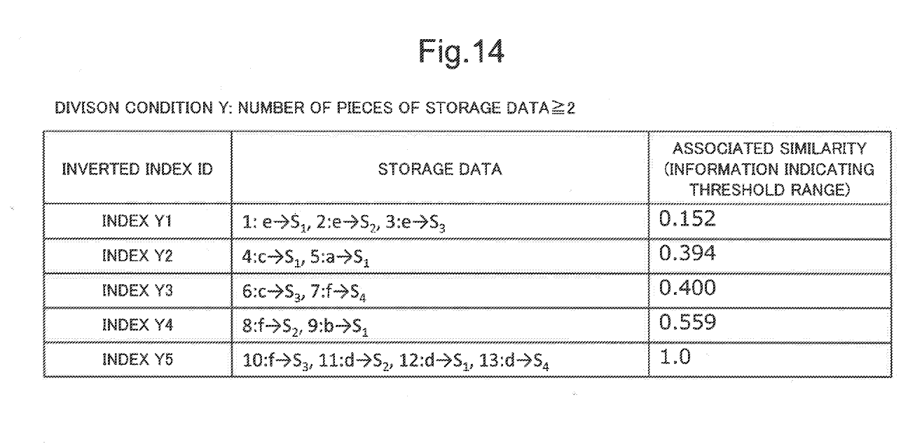

Assume that, for example, in the division condition Y, the number of pieces of data stored in each inverted index is equal to or more than 2. FIG. 14 is a diagram illustrating an inverted index generated based on the division condition Y.

First, the inverted index generation unit 25 generates inverted indexes in such a way as to include, among the triads illustrated in FIG. 12, two or more triads each in order from a triad having higher similarity. Triads having the same value as similarity are forced to be included in the same inverted index. In the example of FIG. 12, there are four triads (ID=10, 11, 12, and 13) of which the similarity is the maximum value 1.0. The inverted index generation unit 25 generates inverted index including these four triads. Therefore the inverted index generation unit 25 generates, among the remaining three triads, a next inverted index in such a way as to include two or more triads (in this case, triads of ID=8 and 9) in order from a triad having higher similarity. Thereafter, similarly, the inverted index generation unit 25 generates, from among the remaining triads, an inverted index in such a way as to include two or more triads in order from a triad having higher similarity. As a result, as illustrated in FIG. 14, five inverted indexes Y1 to Y5 are obtained. The inverted index generation unit 25 associates each inverted index with the maximum value of similarities associated with stored triads as information indicating an enabled threshold range.

<Search Operation Using an Inverted Index (Specific Example)>

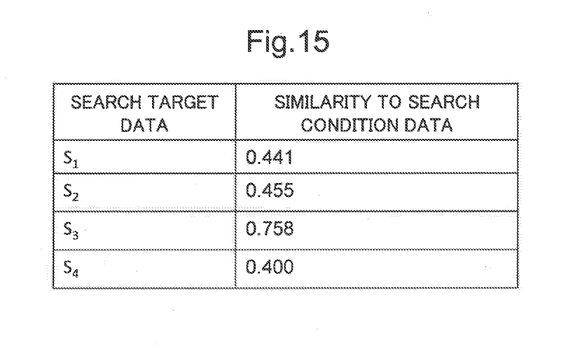

Next, by using the inverted indexes illustrated in FIG. 13 or FIG. 14, an operation for executing search processing is described. It is assumed that as search condition data, a set T={a,b,e,f} is used. FIG. 15 illustrates similarity between T and search target data S1 to S4 calculated by the equation of definition 2. When, for example, a threshold of similarity 0.7 is specified and search is executed, it is correct that S₃ of which the similarity is equal to or more than 0.7 is obtained as the search result. When a threshold of similarity 0.45 is specified and search is executed, it is correct that S3 and S2 of which the similarity is equal to or more than 0.45 are obtained as the search result.

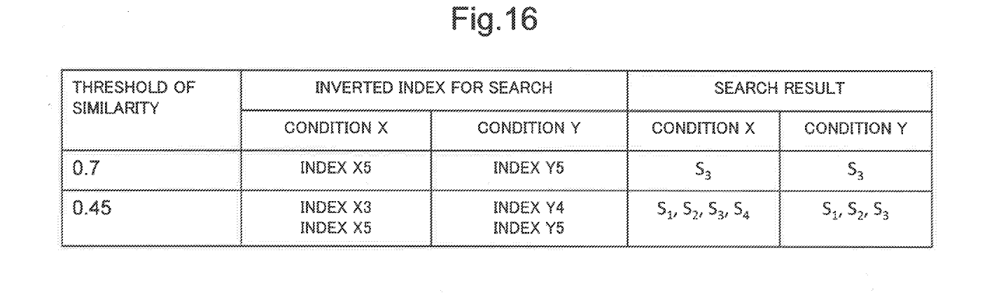

FIG. 16 is a diagram illustrating a situation where a search result is narrowed down.

First, a case is described where the similarity threshold is 0.7 and inverted indexes generated under the division condition X are the target. In this case, the inverted index selection unit 12 selects, from among the inverted indexes X1 to X5 generated under the division condition X, the inverted index X5 of which the associated similarity is equal to or more than 0.7, as the inverted index for search. The data search unit 23 searches for data similar to search condition data T using the inverted index X5. Specifically, the data search unit 23 searches the inverted index X5 using each of the elements a, b, e, and f of T as a key. Thereby, S₃ is obtained as a search result. The data search unit 23 calculates again similarity between T and S3 and confirms that similarity is equal to or more than the threshold 0.7. As a result, the data search unit 23 finally outputs S3 as a similarity search result. In this manner, the similar data search device 2 narrows down the inverted indexes used for search, using the similarity threshold and largely narrows down the target of which the similarity to T must be calculated. As a result, the similar data search device 2 can reduce total amount of calculation and obtain the search result at high speed.

In a general method for storing S1 to S4 in one inverted index, without an inverted index enabled for a threshold range, any of S1 to S4 contains an element common to T. Therefore, in a general method, as a search result using an inverted index based on T, all of S1 to S4 are obtained. Therefore, in a general method, thereafter, similarity to T must be calculated for all of S1 to S4, and a narrowing-down effect of the inverted indexes is not substantially produced.

Next a case is described where the similarity threshold is 0.7 and the inverted indexes are generated under the division condition Y. In this case, the inverted index selection unit 12 selects, among inverted indexes Y1 to Y5 generated under the division condition Y, the inverted index Y5 as an inverted index for search, where the associated similarity is equal to or more than 0.7. The data search unit 23 searches for data similar to search condition data T by using the inverted index Y5. Specifically, the data search unit 23 searches the inverted index Y5 using each of the elements a, b, e, and f of T as a key. Thereby, S3 is obtained as a search result. The data search unit 23 calculates similarity between T and S3 and confirms that similarity is equal to or more than the threshold 0.7. In this manner, the similar data search device 2 outputs S3 as the final similarity search result. This is similar to the above-described case.

Next, a case is described where the similarity threshold is 0.45 and the inverted indexes are generated under the division condition X. In this case, the inverted index selection unit 12 selects, from among the inverted indexes X1 to X5 generated under the division condition X, the inverted indexes X3 and X5 as the inverted indexes for search, of which the associated similarity is equal to or more than 0.45. The data search unit 23 executes search using these inverted indexes, with each element of T as a key. Thereby, S1, S2, S3, and S4 are obtained as a search result. Thereafter, the data search unit 23 calculates similarity between each of S1, S2, S3, and S4 and T and obtains, as a search result, S2 and S3 in which the calculated similarity is equal to or more than a threshold 0.45. In this case, as a search result of an inverted index for search, all of search target data are obtained, and therefore a narrowing-down effect based on the inverted indexes is not specifically obtained.

Next, a case is described where the similarity threshold is 0.45 and the inverted indexes are generated under the division condition Y. In this case, the inverted index selection unit 12 selects, from among the inverted indexes Y1 to Y5 generated under the division condition Y, the inverted indexes Y4 and Y5 of which the associated similarity is equal to or more than 0.45 as the inverted indexes for search. The data search unit 23 executes search by using each element of T as a key, using these inverted indexes. Thereby, S1, S2, and S3 are obtained as the search result. Thereafter, the data search unit 23 calculates similarity between each of S1, S2, and S3 and T and obtains, as the search result, S2 and S3 of which the calculated similarity is equal to or more than the threshold 0.45. In this case, by searching the inverted indexes, S4 has been successfully excluded from the result candidates, and therefore a narrowing-down effect based on the inverted indexes is obtained.

In general, as division of inverted index is finer, a narrowing-down effect is more easily obtained. However, when division is excessively fine, the number of times of search for an inverted index increases, and therefore a performance degradation is predicted. A division condition is preferably determined for each task, by considering a balance between a narrowing-down effect and search performance.

This concludes description with specific examples.

[Description of an Advantageous Effect]

Next, an advantageous effect of the second example embodiment of the present invention is described.

The similar data search device of the present example embodiment can generate enabled inverted indexes that need not be regenerated on a change of a similarity threshold, and execute search based on sets similarity at higher speed, even when similarity may take an arbitrary real number value.

The reason is described in the following. In the present example embodiment, the division condition acquisition unit 24 obtains information indicating a division condition for generating a plurality of inverted indexes from search target data. The inverted index generation unit 25 generates, based on the obtained division condition, a plurality of inverted indexes from search target data.

The generated inverted indexes each are generated in such a way as to be enabled for a threshold range of similarity. The inverted indexes are generated in such a way that, for at least one inverted index, a part or the whole of a threshold range where the inverted index is enabled is not included in a threshold range where at least one other inverted index is enabled. The inverted index selection unit 12 selects, from among a plurality of inverted indexes, one or more inverted indexes for search, based on the similarity threshold specified upon search and a threshold range where each inverted index is enabled. The data search unit 23 searches for search target data similar to search condition data, using the inverted index for search.

In this manner, in the present example embodiment, the similar data search device 2 can generate, based on a division condition, from search target data, more appropriate inverted indexes that need not be regenerated on a change of the similarity threshold specified upon search even when similarity may take any real number value. As a result, the similar data search device 2 in the present example embodiment can execute search at higher speed using more appropriate inverted indexes, regardless of a change of the similarity threshold specified upon search.

### Third Example Embodiment

Next, a third example embodiment of the present invention is described in detail with reference to the drawings. In the present example embodiment, an example is described where similar data are searched using a priority threshold having a higher value than the similarity threshold, in addition to the similarity threshold. In the drawings referred to in description of the present example embodiment, the same component as in the first example embodiment of the present invention and a step similarly operated are assigned with the same reference signs, and their detailed description in the present example embodiment is omitted.

[Description of a Configuration]

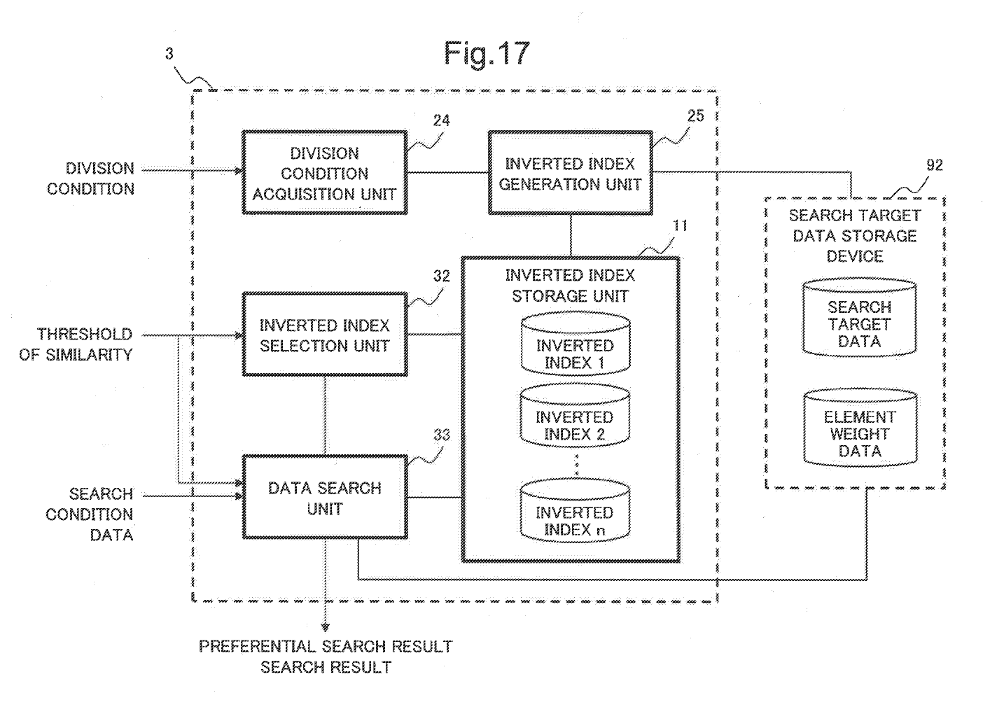

First, a configuration of function blocks of a similar data search device 3 as the third example embodiment of the present invention is illustrated in FIG. 17. In FIG. 17, the similar data search device 3 is different from the similar data search device 2 as the second example embodiment of the present invention in a point that instead of the inverted index selection unit 12, an inverted index selection unit 32 is included and instead of the data search unit 23, a data search unit 33 is included.

The similar data search device 3 and each function block thereof can be configured by using hardware elements similar to the corresponding hardware elements of the first example embodiment of the present invention described with reference to FIG. 2. However, hardware configurations of the similar data search device 3 and each function block thereof are not limited to the above-described configurations.

The inverted index selection unit 32 selects an inverted index for search, similarly to the second example embodiment of the present invention and in addition, selects an inverted index for priority search as follows. In other words, the inverted index selection unit 32 selects an inverted index for priority search, based on the priority threshold having a higher value than the similarity threshold. The priority search refers to search that is executed by the data search unit 33 with higher priority compared to search based on inverted indexes for search described in the second example embodiment of the present invention. Hereinafter, search based on inverted indexes for search described in the second example embodiment of the present invention is also described as normal search. The inverted index selection unit 32 may select, as an inverted index for priority search, for example, one or more inverted indexes included in a threshold range where the priority threshold is enabled. One or a plurality of inverted indexes for priority search to be selected are applicable.

The data search unit 33 execute normal search using the inverted indexes for search, similarly to the second example embodiment of the present invention, and in addition, executes priority search using the inverted indexes for priority search. The data search unit 33 outputs a result of the priority search preferentially to a result of the normal search.

The data search unit 33 may, for example, execute priority search preferentially to normal search and output the search result thereof, and thereafter execute normal search, similarly to the second example embodiment of the present invention and output the search result thereof. However, it is not always necessary for the data search unit 33 to start normal search after all outputs of results of priority search are completed. The data search unit 33 may execute normal search and priority search in such a way that an output of an priority search result is executed ahead of an output of the search result in the second example embodiment.

<Description of an Operation>

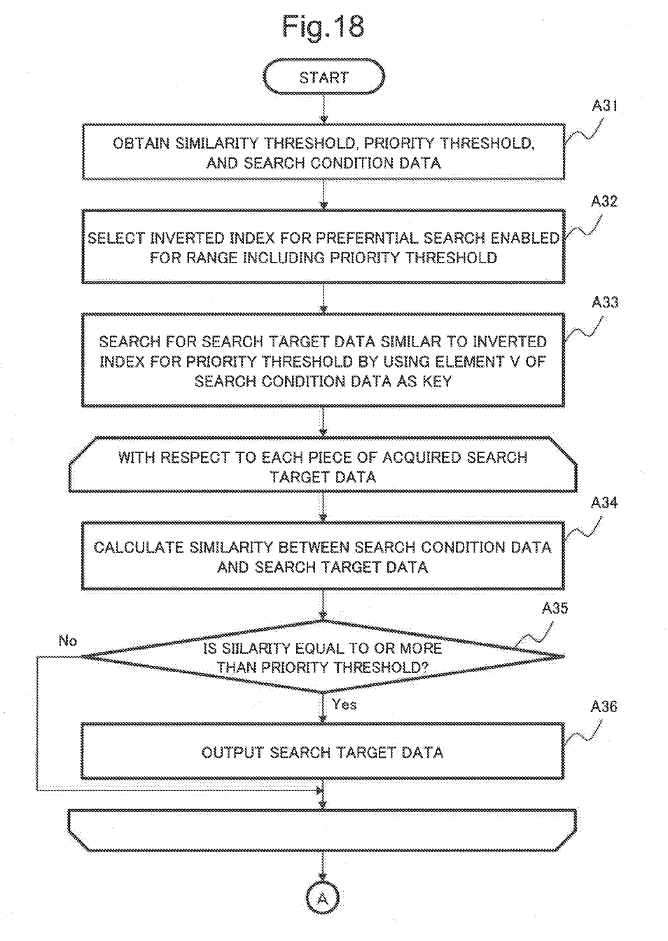

An operation of the similar data search device 3 configured as described above is described with reference to FIG. 18. A generation operation for an inverted index of the similar data search device 3 is similar to the generation operation of the second example embodiment of the present invention illustrated in FIG. 6, and therefore description in the present example embodiment is omitted.

<Search Operation Using an Inverted Index>

An operation for executing search by the similar data search device 3 is described by using FIG. 8. This is an operation for determining all S∈Σ with sim(S, T)≥λ, with respect to input search condition data T and outputting the determined S∈Σ.

In FIG. 18, first, the inverted index selection unit 32 obtains the similarity threshold λ, the priority threshold λₚ, and search condition data T (step A31).

The inverted index selection unit 32 selects an inverted index for priority search, based on the priority threshold λₚ (step A32).

Specifically, the inverted index selection unit 32 selects, as the inverted indexes for priority search, the inverted indexes where the priority threshold λₚ is included in the enabled threshold range.

It is assumed that, for example, inverted indexes 1 to 5 are associated with similarities 0.2, 0.4, 0.6, 0.8, and 1.0, respectively. In other words, it is assumed that the inverted indexes 1 to 5 are configured to be enabled in search where thresholds equal to or less than 0.2, 0.4, 0.6, 0.8, and 1.0 are specified, respectively. It is assumed that the similarity threshold λ is 0.7 and the priority threshold λₚ is 0.9.

In this case, the inverted index selection unit 32 selects, as an inverted index for priority search, the inverted index 5 associated with 1.0 that is equal to or more than the priority threshold λₚ.

The data search unit 33 executes search using each element v of the search condition data T as a key, by using the inverted index for priority search (step A33).

The data search unit 33 repeats the following steps A34 to A36 with respect to each of Sₚ∈Σ obtained in step A33.

First, the data search unit 33 calculates similarity sim(Sₚ, T) between Sₚ and T (step A34).

The data search unit 33 determines whether the calculated similarity is equal to or more than λₚ (if sim(Sₚ, T)≥λₚ) (step A35).

If the similarity is equal to or more than λₚ (Yes in step A35), the data search unit 33 determines that Sₚ and T are similar to each other and outputs Sₚ as a priority search result (step A36).

On the other hand, if the similarity is smaller than λₚ (No in step A35), the data search unit 33 determines that Sₚ and T are not similar to each other and does not include such Sₚ as a priority search result.

When steps A34 to A36 are terminated with respect to each of the Sₚ∈Σ obtained in step A32, the similar data search device 3 thereafter executes normal search of steps A1 to A2 and A23 to A26 of FIG. 6, similarly to the second example embodiment of the present invention and outputs then search result.

This concludes the description of an operation for executing search by the similar data search device 3.

Through such an operation, the present example embodiment can preferentially output, even in search where the similarity threshold (e.g. 0.7) is specified, the result of priority search where the similarity is equal to or more than the higher priority threshold (e.g. 0.9). Therefore, a response to the user can be improved.

In the flowcharts of FIG. 18 and FIG. 6 following FIG. 18, the inverted indexes for search to be referred to in normal search of step A23 includes the inverted indexes for priority search to be referred to in priority search of step A33. Therefore, search results may be overlapped. In order to avoid this overlap, the data search unit 33 may omit, for example, search using an inverted index that is also an inverted index for priority search among inverted indexes for search in step A23. The data search unit 33 may temporarily store, Sₚ∈Σ obtained in step A33 of priority search, but determined as No in step A35. In this case, the data search unit 33 may add Sₚ determined as No in step A35 to the target of precise determination of similarity in subsequent steps A24 to A26 of normal search.

[Description of an Advantageous Effect]

An advantageous effect of the third example embodiment of the present invention is described.

The similar data search device 3 of the present example embodiment can more rapidly present, even when the similarity may take any real number value, a search result having higher similarity, upon search using inverted indexes that need not be regenerated on a change of a threshold of similarity.

The reason is described. In the present example embodiment, the similar data search device 3 includes a configuration similar to the configuration of the second example embodiment of the present invention, and in addition, the inverted index selection unit 32 selects one or more inverted indexes for priority search as follows. In short, the inverted index selection unit 32 selects inverted indexes for priority search, based on the priority threshold having a higher value than a threshold of similarity. The data search unit 33 executes normal search using inverted indexes for search and in addition, priority search using inverted indexes for priority search, and thereby outputs a result of priority search preferentially to a result of normal search.

In this manner, the present example embodiment can meet a need to obtain search results with especially high similarity quicker than other results. The reason is that in practice, in many cases, it is almost sufficient if a search result with especially high similarity could be obtained at high speed, and it is allowable to take time until obtaining all other results.

In the second and third example embodiments of the present invention described above, the definition of similarity can be further generalized.

In the above-described example embodiments, description has been made, assuming, as an example, that definition 2 is applied to search condition data T and search target data S as similarity sim(S, T) between S and T.

sim(S,T)=Weight(S∩T)/Weight(S) (Definition 2)

This is further generalized, and thereby similarity sim(S, T) can be expanded to the following definition 2′.

sim(S,T)=Weight(S∩T)/(f(S)·g(T)) (Definition 2′)

wherein f(S) may be a function from S to a positive real number and g(T) may also be a function from T to a positive real number, and a specific content thereof is not specifically limited. Definition 2 employed in the above description is just a special case of definition 2′ where f(S)=Weight(S) and g(T)=1.

Under definition 2′, following definition 3′ is employed instead of definition 3.

λᵢ=Weight(S\Sᵢ)/f(S) (Definition 3′)

If Sᵢ∩T=Φ and λᵢ<μ·g(T),

Weight(S∩T)/f(S)=Weight((S\Sᵢ)∩T)/f(S)≤Weight(S\Sᵢ)/f(S)=λᵢ<μ·g (T), and therefore
sim(S, T)=Weight(S∩T)/(f(S)·g(T))<μ, holds. In other words, by accordingly replacing the definition of S(μ) as “S(μ)={s|s∈S and λᵢ₍ₛ₎<μ·g(T)}” in property 2, the same content “when a set T of search condition satisfies sim(S,T)≥μ, T∩S(μ)≠Φ” holds.

In this case, the inverted index generation unit in each example embodiment may generate a triad in which a value calculated based on definition 3′ is a third element and integrates the generated triad as inverted indexes. The inverted index selection unit in each example embodiment select, when searching for similar data, based on the similarity threshold μ, one or more inverted indexes for search where the associated similarity (a maximum value of the values calculated on definition 3′) is equal to or more than μ·g(T). A data search unit of each example embodiment configures the inverted indexes for search selected in this manner in such a way as to execute search, based on each element of T. Thereby, all pieces of search target data similar in equal to or more than the threshold μ can be efficiently searched.

In the third example embodiment, the inverted index selection unit 32 selects, when searching for similar data, based on a priority threshold μₚ, inverted indexes for priority search where the associated similarity (a maximum value of the values calculated on definition 3′) is equal to or more than μₚ·g(T). The data search unit 33 configures the inverted index for priority search selected in this manner in such a way as to execute search, based on each element of T. Thereby, all pieces of search target data similar in equal to or more than a priority threshold μₚ can be efficiently searched.

As described above, also when similarity is defined by definition 2′, the second and third example embodiments of the present invention similarly produce a similar advantageous effect. Each example embodiment can also cope with, for example, a case in which sim(S, T)=Weight(S∩T)/Weight(T) is satisfied by setting f(S)=1 and g(T)=Weight(T).

In the second and third example embodiments of the present invention described above, for further description, similarity is not limited to a real number value calculated based on a non-negative weight provided to elements of a set.

In the example embodiments of the present invention described above, a case in which function blocks of a similar data search device are realized by a CPU for executing a computer program stored on a memory has been mainly described. Without limitation thereto, a part or the whole of the function blocks or a combination thereof may be realized by dedicated hardware.

In the example embodiments of the present invention described above, a function block of a similar data search device may be realized by being distributed to a plurality of devices.

In the example embodiments of the present invention described above, an operation of a similar data search device described with reference to flowcharts may be stored on a storage device (recording medium) of a computer device as a computer program of the present invention. The computer program may be read and executed by the CPU. In such a case, the present invention is configured by using a code of the computer program and a storage medium.

The example embodiments described above can be carried out via an appropriate combination thereof.

The present invention can be carried out by various aspects, without being limited to the example embodiments described above.

The example embodiments described above are applicable, for example, as a similar text search device. A text can be regarded as a set of words. A similar data search device in each example embodiment is suitable as a similar text search device that applies an input text as search condition data and handles a similar text to be searched as search target data, and thereby searches for a text similar to the input text.

The present invention has been described by using the example embodiments described above as exemplary examples. However, the present invention is not limited to the example embodiments described above. In other words, the present invention is applicable with various aspects which can be understood by those skilled in the art, without departing from the scope of the present invention.

This application is based upon and claims the benefit of priority from Japanese patent application No. 2016-137824, filed on Jul. 12, 2016, the disclosure of which is incorporated herein in its entirety by reference.

### REFERENCE SIGNS LIST

1, 2, 3 Similar data search device
11 Inverted index storage unit
12, 32 Inverted index selection unit
13, 23, 33 Data search unit
24 Division condition acquisition unit
25 Inverted index generation unit
91, 92 Search target data storage device
1001 CPU
1002 Memory
1003 Output device
1004 Input device
1005 Communication interface

What is claimed is:

1. A similar data search device comprising:
inverted index storage unit storing a plurality of inverted indexes that are used when searching for, based on similarity between sets, search target data as a set similar to search condition data as a set and that are each enabled for a range of similarity threshold for determining that sets are similar, wherein for at least one inverted index, a part or whole of the threshold range where the inverted index is enabled is not included in the threshold range where at least one other inverted index is enabled;
inverted index selection unit selecting an inverted index for search from among the plurality of inverted indexes, based on the similarity threshold specified upon search and the threshold range where each of the inverted indexes is enabled; and
data search unit searching for the search target data similar to the search condition data by using the selected inverted indexes for search.

2. The similar data search device according to claim 1, further comprising:
division condition acquisition unit acquiring information indicating a division condition for generating the plurality of inverted indexes from the search target data; and
inverted index generation unit generating the plurality of inverted indexes from the search target data, based on the division condition.

3. The similar data search device according to claim 1, wherein
the inverted index selection unit further selects inverted indexes for priority search to be preferentially executed, based on a priority threshold having a higher value than the similarity threshold and the threshold range where each of the inverted indexes is enabled, and
the data search unit further searches for, in addition to search processing using the inverted indexes for search, the search target data similar to the search condition data by using the inverted indexes for priority search, and outputting a search result based on the inverted indexes for priority search preferentially to a search result based on the inverted indexes for search.

4. A method comprising:
by using a computer device,
selecting, by using a plurality of inverted indexes that are used when searching for, based on similarity between sets, search target data as a set similar to search condition data as a set and that are each enabled for a range of similarity threshold for determining that sets are similar, wherein for at least one inverted index, a part or whole of the threshold range where the inverted index is enabled is not included in the threshold range where at least one other inverted index is enabled,
inverted indexes for search from among the plurality of inverted indexes, based on the similarity threshold specified upon search and the threshold range where each of the inverted indexes is enabled; and
searching for the search target data similar to the search condition data by using the inverted indexes for search.

5. A program causing a computer device to execute:
inverted index selection processing of selecting,
by using a plurality of inverted indexes that are used when searching for, based on similarity between sets, search target data as a set similar to search condition data as a set and that are each enabled for a range of similarity threshold for determining that sets are similar, wherein for at least one inverted index, a part or whole of the threshold range where the inverted index is enabled is not included in the threshold range where at least one other inverted index is enabled,
an inverted index for search from among the plurality of inverted indexes, based on the similarity threshold specified upon search and the threshold range where each of the inverted indexes is enabled; and
data search processing of searching for the search target data similar to the search condition data by using the inverted indexes for search.

6. The data search device according to claim 1, wherein
the inverted indexes are associated with the threshold ranges different from one another as the threshold range where the inverted index is enabled, and
the inverted index selection unit determines, for each of the inverted indexes, whether or not the similarity threshold specified upon search is included in the range of similarity threshold associated with the inverted index, and selects, as the inverted index for search, the inverted indexes associated with the range of similarity threshold including the similarity threshold specified upon search.

7. The data search device according to claim 6, wherein
the inverted index stores
one or more sets of data that can identify the elements included in the search target data as a set, the search target data as a set including the element, and the similarity between sets,
a range equal to or less than the maximum value of the similarities between sets with respect to the one or more sets of data stored in the inverted index is associated as the threshold range where the inverted index is enabled, and
the inverted index selection unit selects an inverted index as the inverted index for search, when the similarity threshold specified upon search is equal to or less than the maximum value of the similarity between sets with respect to the one or more sets of data stored in the inverted index.
